(19) United States
(12) Patent Application Publication
(10) Pub. No.: US 2007/0023329 A1
(43) Pub. Date: Feb. 1, 2007

(54) Method for selective removal of ray cells from cellulose pulp

(75) Inventors: Christer Sandberg, Skärblacka (SE); Carl Fredrik Nilsson, Norrkoping (SE); Per Engstrand, Åby (SE)

Correspondence Address: SUGHRUE MION, PLLC, 2100 PENNSYLVANIA AVENUE, N.W., SUITE 800, WASHINGTON, DC, 20037, US

(73) Assignee: HOLMEN AKTIEBOLAG, Stockholm (SE)

(21) Appl. No.: 10/554,913

(22) PCT Filed: Apr. 28, 2004
(86) PCT No.: PCT/SE04/00656

§ 371 Date: Apr. 12, 2006

(30) Foreign Application Priority Data
Apr. 29, 2003 (SE) 0301243-2

(51) Int. Cl. B07B 1/22

(52) U.S. Cl. 209/270

(57) ABSTRACT

The content of ray cells in cellulose pulp causes problems and therefore these ray cells should be removed from the cellulose pulp to improve the pulp quality. The present invention makes this possible and comprises a method wherein at first an advancing pulp suspension is screened or vortex cleaned, (3) leading to the formation of an accept pulp fraction (4) and a reject pulp fraction (5) and that the reject pulp fraction is cleaned and divided, and that accepted material (pulp fibres and valuable fine material) is brought to further treatment and/or use. The invention is characterized in that the cleaning and division of the reject pulp suspension is carried out so that substantially all ray cells are present in the apex fraction of a fractionating cyclone (6) (if that is the kind of device used) and in that said fraction as such constitutes a very limited material stream, or in that a very limited material stream, predominantly containing ray cells is selected from the apex fraction, and in that this very limited material stream is brought to a disposal stage.

### TECHNICAL FIELD

The present invention relates to a method for selective removal of ray cells from cellulose pulp.

The term cellulose pulp includes chemical pulp, semi-chemical pulp and mechanical pulp. Examples of chemical pulps are soda pulp, sulphate pulp, polysulfide pulp and sulphite pulp. Mechanical pulps can be divided in groundwood pulp (GW), pressurized groundwood pulp (PGW), refiner mechanical pulp (RMP), thermomechanical pulp (TMP) and chemi-thermomechanical pulp (CTMP). The starting material for the production of these pulps is one or more lignocellulose materials. The dominating material ofthat kind is wood originating from softwood as well as hardwood. In spruce (Picea Abies) app. 4 volume percent of the wood fibers are ray cells, i.e. ray tracheids and parenchymatous cells (Tracheidal and Parenchumataous Cells in Picea Abies (Karst.) Pulpwood and Their Behaviour in Sulphite Pulping), Sv. Papperstidning No. 20, 31 okt. 960, p. 695-698, Ernst Back. For other wood species the amount of ray cells can be higher (Textbook of Wood Technology, 4^{th} Edition McGraw-Hill Book Company, A. J. Panshin, Carl de Zeeuw).

### BACKGROUND ART

Persons skilled in the art have for a long time recognized the desirability to remove ray cells from the cellulose pulp, either temporarily or definitely. There are many inconveniences associated with this cellulose pulp fraction and the inconveniences depend on the purpose for which the pulp shall be used. One big problem with ray cells is their form and size. They are very small and have a rectangular, brick like form. Further the thick cell walls contain comparatively much lignin and the content of transition metals is also very high compared to the content in common wood and pulp fibers. In addition there is a substantially increased content of resin compared to said wood and pulp fibers.

The binding capacity of untreated ray cells is inferior to the binding capacity of common pulp fibers. This binding capacity can be improved if the ray cells are treated in any, preferably chemical or biotechnological, way. It shall be noted that ray cells in mechanical pulps give rise to more and/or at least greater problems than ray cells in chemical pulps and there is also, regarding ray cells in especially mechanical pulps, a possibility that they can be taken care of after having been removed from the pulp and thereafter been furnished with an oxidation (bleaching) chemical, e.g. a peroxide.

One idea has been to remove the ray cells, once and for all, from the pulp by collecting them in a reject fraction, and allow this fraction to leave the pulp production process. The problem with this is that in this reject much other material than ray cells are gathered, including valuable, badly treated common pulp fibers, and valuable fine material. This means that the amount of reject becomes unacceptably large leading to an obvious economical burden, for example at the following paper production.

U.S. Pat. No. 4,731,160 describes fractionating of mechanical pulp at an early stage, creating two streams of material, one main material stream containing ordinary or prime pulp fibers and a minority stream of material containing so called fine material or “fines”. This fraction includes ray cells. These two pulp suspension streams are bleached separately, for example with hydrogen peroxide, and it is preferred that the main pulp suspension stream is subjected to displacement bleaching, which is a bleaching technology that can not be used for the stream containing fines. After finished bleaching these two materials or pulp streams are brought together to one pulp stream for transport to e.g. a paper machine.

If ones take a closer look how the fractionating of the pulp to remove, among other things, the ray cells from the main pulp suspension stream is accomplished, one will find that the lignocellulose material (the wood) is refined in two steps and then the pulp suspension is conducted to a fractionating device 15, which divides the suspension in one prime pulp fibre portion, which is carried away through the line 18, and a fine material fraction (“fines”), which is carried away through the line 19 to a further fractionating device 16. In this device the material is divided in one stream containing steam which is carried away through the line 22 and one stream containing fines which is carried away through the line 21. As far as one can judge, the devices 15 and 16 consist of steam cyclones and that type of fractionating devices are inferior when it comes to selective separation of prime pulp fibers from fines and they are not at all capable of separating ray cells from other fines.

The above described is proven by what is said in column 3, the last paragraph in the patent publication, where one can read that the fines portion extends up to 10-20 wt % of the total amount of pulp. As have been mentioned before, the volume of the ray cells amounts to app. 4% when spruce is used as raw material.

In the Swedish Patent Publication 517 297 (9903215-3) is a method for production of mechanical pulp from a cellulose based material shown and described, wherein the material is treated in at least one refinery stage to produce a pulp, and wherein the pulp is fractionated after a first refinery stage for separating a primary fine material from the pulp and wherein the method is characterized in that said separated fine material is carried away from said pulp production.

The primary fine material is something that consists predominantly of fragments of middle lamellas of the pulp fibres and material which originates from ray cells. The amount of such primary fine material which is removed from the pulp is 3-15%, preferably 5-10%.

Concerning the interesting thing here, i.e. the way in which the primary fine material is removed, the Patent Publication learns that the fractionating is carried out preferably by screening in any suitable screen, preferably in at least one curved screen. It is also possible to centrifuge the pulp, preferably in at least one cyclone. The fractionating can also be carried out in at least two stages. FIGS. 1 and 2 show only a curved screen type of a fractionating device.

The above mentioned and showed fractionating device (fractionating method) is in no way advanced, neither especially selective, concerning the separation of ray cells.

The magazine Pulp & Paper Canada T307 101:10 (2000) III, pages 83-87 published an article of interest titled “The effect of various mechanical and chemical treatment of ray cells on sheet properties and linting.”

This article learns among other things:

Page 83, the first column, the last paragraph,

“A possible alternative to reduce linting is selective removal of material of low specific surface with hydrocyclone “cleaning”. The significance of cleaners for fractionation by surface area and bonding potential has been recognized in the past [1,16]. The idea has been revived recently with the appearance in the market of specially designed hydrocyclones said to fractionate and remove this type of material [17]. Efficient separation of the lint candidate material solves only part of the problem; what to do with it remains a problem.”
   Page 86, the first column, the last but one paragraph,
“Alkaline peroxide bleaching should reduce the linting propensity of otherwise equivalent mechanical printing papers. Removal of ray cells from white-water by hydrocyclone cleaning, or from pulp by combination of screening and cleaning followed by simple alkaline peroxide treatment and return of the ray cells to the furnish without additional mechanical treatment, should improve the bonding of the ray cells. Mechanical printing papers containing such chemically treated ray cells should have increased surface strength and reduced linting propensity. The costs and economic benefits of such an approach remain to be established. ”

From this it appears that pulp can be liberated from its content of ray cells through a combination of screening and vortex cleaning of the pulp. However there are no closer information of how that is to be done and therefore the person skilled in the art has doubts about how this shall be done.

In the article commented upon there are a reference to a lecture given at the 20^{th} International Mechanical Pulping Conference, Stockholm 1997, titled “The dual demand on fibres in SC-papers”, Hans-Erik Höydahl and Göran Dahlqvist, pages 337-44.

Nor this lecture gives a person skilled in the art any concrete information of how the removal of ray cells from pulp shall be done.

Below is given some passages from the text on page 341 in the lecture:
“Screens and centricleaners treating mechanical pulps for shive removal are ((leaking)) accept material containing a significant amount of fibre particles that have a low degree of treatment of the fibre wall.
   It is, therefore, of importance to find a selective separation method which collects this low energy material for further treatment. Techniques are available today that effectively separate untreated ((low energy)) fibre material from acceptable fibre material. These are specially designed fibre separating hydocyclones which are simple and cheap. But since the general attitude of the industry is to reduce process steps rather than adding them, the progress in this field has been slow, at least up until now.
   In the case of separating shives and ((low energy)) material from the pulp, we, therefore, have to accept that there is a need for two different principles of separation. That is, fibre-bundles/shives have to be rejected in slotted screens while ((low energy material)) can only be separated from the acceptable fibres in specially designed hydrocyclones.
   When mechanical pulp with this type of ((low energy material)) goes to the paper machine without sufficient treatment, which is the case in most installations, we find an over-population of thick-walled fibres that are detrimental to the surface properties as well as the optical properties of the SC paper [7].”

### DISCLOSURE OF THE INVENTION

Technical Problem

It appears from what is mentioned above that some persons skilled in the art since long have thought that ray cells among other things should be temporarily or definitely removed from the pulp to improve the quality of the pulp. Proposals have been presented how to achieve this, but nothing has been presented that in detail shows how these ray cells selectively and effectively can be removed from the cellulose pulp.

The Solution

The present invention meets these demands and solves this problem and offers a method for selective removal of ray cells from cellulose pulp wherein at first an advancing pulp suspension is screened or vortex cleaned, whereas an accept pulp suspension and a reject pulp suspension are provided, and the reject pulp suspension is cleaned and divided and that accept material (pulp fibers and usable fines) is brought to further treatment and/or use, characterized in that the cleaning and division of the reject pulp suspension is carried out so that substantially all ray cells are recovered in the apex fraction of a fractionating cyclone (if that kind of device is used) and in that said fraction as such constitutes of very limited material stream containing predominantly ray cells or in that a very small material stream containing predominantly ray cells is selected from the apex fraction, and in that this very limited material stream is brought to a disposal stage.

The introductory screening of the pulp suspension can be made in a pressurized screen with a screen plate provided with long and narrow slots with a width up to 0.1 mm or circular holes with a diameter up to 0.5 mm. Optionally a curved screen is used. Said separation of material can also be carried out in a device like a wire washer and drum filter and these devices are, in this context, comparable with screens.

When it comes to the cleaning and separating of the reject pulp suspension, this is carried out with a device that separates the reject or the fine material according to the specific surface of the different fractions. The ray cells have significantly lower specific surface than is the case with other fine material, which makes it possible to separate the ray cells in devices that take advantage of differences in the hydrodynamic resistance of different types of fine material. Useful devices are fractionating cyclones. Other devices can also be used if they rely on the same principle as fractionating cyclones. Examples of such devices are certain types of sedimentation equipments. The devices must be optimized in special ways, i.e. a certain balance must be established between the hydrodynamic flow force and the gravitational/centrifugal force.

The measures described above to remove ray cells from the pulp can be implemented in any position from just after the fibre liberation stage to the short circulation, when the pulp is used for paper/paperboard production.

Even though the described technique can be used for refining all types of pulps, it has its greatest importance in refining mechanical pulp. In such pulp production it is advantageous to implement said measures directly after the fibre liberation, i.e. just after the defibration in one or two stages of the lignocellulose material. In this way the risk that resins from the ray cells migrates into the suspension liquid is minimized.

The method according to the invention aims to reduce the amount of fine material primarily in the form of ray cells which are removed from the cellulose pulp to at most 5% of the original weight of the cellulose pulp. Further the amount of ray cells in the fine material taken out or expelled is entirely dominating and amounts to at least 80%. Another circumstance worth to mention is that the amount of ray cells which nevertheless remain in the cellulose pulp falls below 3% of the original amount of ray cells.

The removed and expelled ray cells are brought to a disposal stage as has been mentioned before.

One possible disposal stage comprises an incinerator where the material, after concentration, is incinerated under heat production. The material can also be destructed in other ways. Another possibility is to send the ray cells to a recipient.

It is also possible to utilize the ray cells and refine them with mechanical and/or chemical methods. Their inferior binding capacity can for example be improved by a (bleaching) oxidative treatment as by hydrogen peroxide bleaching or ozone bleaching. After such a treatment the material can be mixed into a pulp furnish or a stock containing high quality pulp fibers.

The above mentioned treatments of expelled ray cells, often in a mixture with other fine material, i.e. what just has been described above, are known technology and constitute no part of the invention.

Advantages

If one is successful with the method according to the invention several advantages are achieved, which have been described by several persons skilled in the art and especially in the literature references, which have been commented under the background art section.

If the ray cells are allowed to stay intact in a pulp suspension, these cells contribute to a drainage behaviour of the pulp- or paper sheets formed of the pulp suspension which is not optimal. If the ray cells are removed, the opposite is true.

Because the ray cells contain a relatively large amount of lignin, resin and transitions metals, bleaching of a not cleaned cellulose pulp will result in an unnecessary bad bleaching result, for example a too low pulp brightness and/or too high bleaching chemical consumption. A removal of ray cells from the pulp before it is bleached leads to a good bleaching result.

A paper sheet containing the original, intact ray cells, shows unnecessarily bad strength values. A paper sheet produced of cellulose pulp liberated from ray cells shows for example higher tensile index as well as tearing resistance than a paper sheet produced of not treated (cleaned) pulp. The difference in tensile index can be 15% at a certain freeness value for the pulp.

Even when producing absorption products such as soft crepe paper, the presence of intact ray cells leads to various problems. These problems will not occur if the ray cells are removed from the pulp.

It should also be mentioned that by offset printing of a paper containing intact ray cells, there will, to a certain extent, always be depositions on rubber cloths and printing plates. The depositions consists mainly of ray cells and lead to shutdown and cleaning of the printing press, which in turn lead to increased costs for the printing work. This problem will be eliminated to a great extent if the pulp is liberated from its ray cells.

Linting problems at the production as well as at converting of various paper types are partly caused by the starting material, i.e. the content of ray cells in the pulp. A removal of ray cells from the pulp means at least a part solution of this problem.

### DESCRIPTION OF THE DRAWINGS

FIG. 1 represents a simplified flow sheet of the production of TMP illustrating the most simple mode of carrying out the method according to the invention.

FIG. 2 represents a simplified flow sheet of the production of TMP illustrating another mode of carrying out the method according to the invention.

FIG. 3 represents a simplified flow sheet of the production of TMP illustrating a third mode of carrying out the method according to the invention.

### BEST EMBODIMENT

With reference to said flow sheets, a number of embodiments of the method according to the invention will now be described, where some circumstances will be explained relatively thoroughly and finally there will be given a working example.

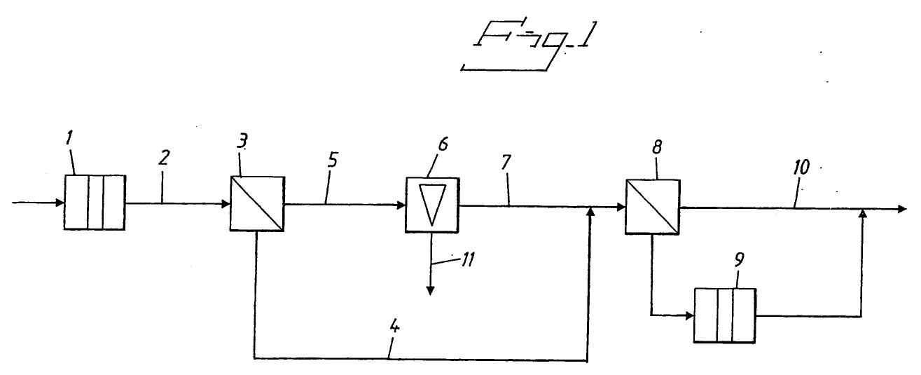

FIG. 1 shows how wood chips are brought to a refiner 1, where the fibre liberation takes place. The fibre liberation can take place in one or more steps. The produced pulp suspension is conducted through line 2 to one or more screens 3, where the pulp suspension is screened in one or more steps. The screen shall be of the type previously described. In between the fibre liberation and the screening operation, the pulp fibers often pass a collection tank and/or a latency tank (not shown in the Figure). An accept pulp suspension stream is conducted through line 4 further on into the system. The remaining material in the form of a reject pulp suspension stream is conducted through line 5 to a cleaning and separating stage 6. The cleaning device consists of a fractionating cyclone, which is different from earlier known, conventional vortex cleaners. Usually two suspension streams leave such a cyclone and they are usually termed apex fraction and base fraction. In this case the base fraction consists of valuable fine material usable for paper production, which is transported away through line 7. Also the accept pulp suspension is conducted to this line through line 4. The accept material is carried further on and is subjected to traditional screening and/or vortex cleaning in position 8. Extracted reject can be refined in position 9 and the refined reject can be returned to the main pulp suspension stream in line 1. For example this material stream is conducted to a paper mill.

The apex fraction from the cyclone cleaning 6, which contains all original ray cells, is conducted through line 11 to a disposal stage.

The most distinguishing feature with the technique above is stage 6, comprising a fractionating cyclone. This is of a type described earlier, but the cyclone must be adjusted so that the material stream that leaves the apex of the cyclone is limited as to the amount and dominated by ray cells.

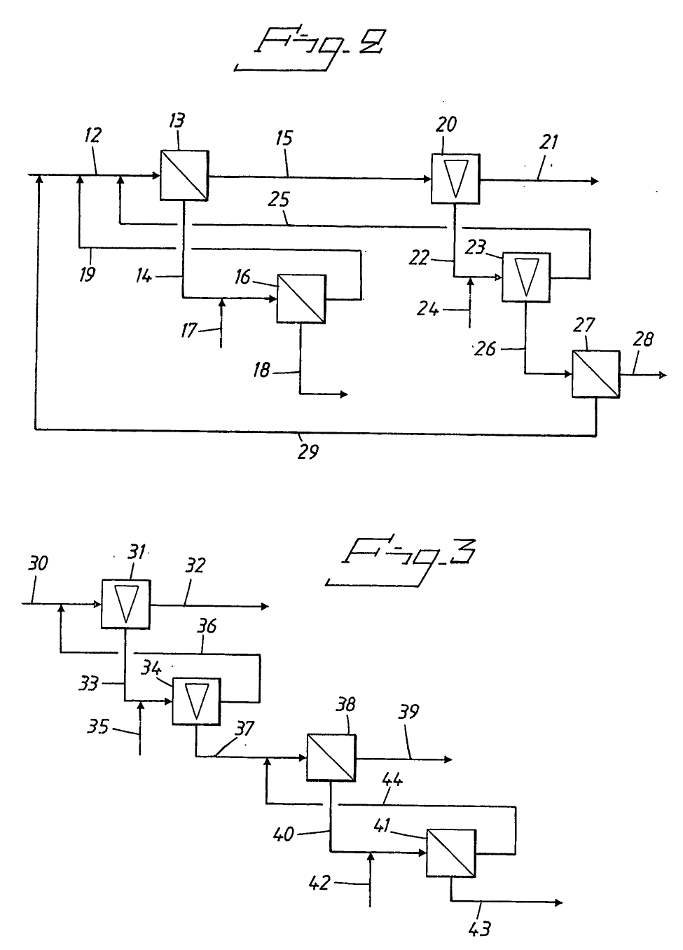

FIG. 2 is an even more simplified flow sheet of TMP production where only the stages according to the invention are present.

A pulp suspension is conducted through line 12 to a screen 13 of the type described earlier. In this screen the pulp suspension is divided in an accept pulp suspension which is taken out through line 14 and a reject pulp suspension which is taken out through line 15. The pulp suspension in line 14 is conducted to a screen 16 of the type described earlier, for example a pressurized screen. On its way to the screening stage 16 the pulp suspension is diluted with white water, termed for example clear filtrate, which is introduced through line 17. In the screening stage 16 the pulp suspension is divided in an accept pulp fibre stream, which is taken away (e.g. to a paper machine). through line 18 and a reject pulp fibre stream, which is returned to the incoming and original pulp suspension through line 19.

The pulp suspension in line 15 is conducted to a fractionating cyclone 2. The fine material in question is in this position divided in usable (valuable) fine material, which is taken out as the base fraction and is transported further on through the line 21 and in fine material which contains almost all the original amount of ray cells, taken out as the apex fraction and is conducted away in line 22. The usable fine material in line 21 is preferably mixed with the accept pulp fibre stream in line 18 which for example has a paper machine as the final destination. The fine material in line 22, rich in ray cells, is diluted on its way to the fractionating cyclone 23, e.g. with clear filtrate that is supplied through line 24. The material rich of ray cells is splitted in cyclone 23 in a base fraction, which is returned to the incoming and original pulp suspension through line 25 and an apex fraction, with an even larger enrichment of ray cells, which is taken out and is transported away in line 26. Said fraction is conducted to a screen 27, which can be a pressurized screen with a screen plate provided with holes. The hole diameter shall be extremely small, for example 0.2 - 0.4 mm. In this screen the fines fraction is divided in one fraction, which predominantly consists of ray cells, which through line 28 is conducted to a disposal stage and in one fraction which contains prime pulp fibers, which through line 29 is returned to the incoming and origin pulp suspension.

The description above is a preferred mode of carrying out the method according to the invention. Because respective cleaning operation of the cellulose pulp is carried out in several steps and at different pulp concentrations, a high selectivity and collecting efficiency for the ray cells is achieved. Such a system is very robust and manages to take care of significant changes in the TMP production.

FIG. 3 is also a very simplified flow sheet of TMP production, where only stages according to the invention are present.

A pulp suspension is conducted through line 30 to a fractionating cyclone 31. This cyclone divides the pulp suspension in a base fraction that is taken away through line 32 and an apex fraction which also can be termed reject fraction, which is taken out and conducted further through line 33. The base fraction in line 32 contains prime pulp fibers and usable (valuable) fine material which fraction is transported to e.g. a paper machine. The apex fraction consists of fine material, including ray cells and thick walled pulp fibers (e.g. summer fibers) and/or insufficient fibrillized fibers. This fraction is conducted to another fractionating cyclone 34. On its way to the cyclone, this pulp suspension is diluted with the clear filtrate, which is supplied through line 35. The base fraction, recovered in cyclone 34, is returned to the system through line 36 to the incoming and original pulp suspension. It is also possible to conduct this base fraction directly to the accept pulp which is taken away in line 32.

The apex fraction, recovered in the cyclone 34, is conducted through line 37 to e.g. a pressurized screen 38. The screen plate can be provided with narrow oblong slots or with holes with very small diameter. The material fraction that is brought to a disposal stage through line 39 consists of predominantly ray cells. The remaining material is conducted through line 40 to another screen 41, e.g. of the same type as screen 38. On its way this material or pulp suspension is diluted with clear filtrate which is supplied through line 42. In the screening stage a fraction with a considerable amount of in some way defect pulp fibers is recovered. This fraction is transported through line 43 to an optional treatment stage, e.g. a refiner, before the material is mixed with the accept material, which is transported in line 32. The other fraction from screen 41 is conducted through line 44 back to the pulp suspension, which is introduced to the screening stage 38.

The just above described method is not preferred but constitutes a fully possible embodiment of the invention.

### EXAMPLE 1

In a factory for production of thermomechanical pulp (TMP) sample of such a pulp was collected in one position which will be specified below.

The starting material for the pulp production was fresh Scandinavian spruce wood with an estimated content of ray cells of app. four volume percent (corresponding to app. five weight percent). After debarking of the spruce logs they were chipped, after which followed conventional screening of the chips and the accepted chips were pretreated according to the following. The chips were preheated in a steam tank and were then washed in a chip washer. The steam treated and washed chips were fed into a comprimating screw, whereupon the material was supplied to a steam preheater with app. 2 bar absolute pressure. The dwell time was app. 3 min.

After that the chips were supplied to a single disc refiner with a diameter of 58 inch type RLP 58 (Sunds Defibrator AB). Within the refiner the pressure was 3.5 bar. The speed of rotation was 1.500 rpm. The fibre liberated wood material, i.e. the produced pulp suspension, was brought to another fibre liberation or defibering stage in a refiner like the one described above. Before the pulp suspension reached the second defibering stage, a great amount of sample material was taken out. At that point the pulp had a drainage ability of 500 ml measured as Canadian Standard Freeness (CSF) or freeness value.

This pulp was brought with a tanker lorry to a pilot plant which had an arrangement of ingoing devices similar to the one in FIG. 2, to which reference is made. In this plant experiments were made which simulated an embodiment of the present invention.

The flow sheet in FIG. 2 was not strictly followed and the following divergences can be noted. The material stream in line 19 was supplied to line 15 (instead of line 12) and the material stream in line 25 was supplied to line 15 (instead of line 12) and the material stream in line 29 was supplied to line 18 (instead of line 12).

The screen 13 was a pressurized screen type TAP 50 (from Valmet-Tampella OY) with a slot width of 0.06 mm. The same type of screen was used in position 16. The fractionating cyclones in positions 20 and 23 were of type AM 80F (from Noss AB). The volumetric withdrawal in these was 20% and the pressure drop was 2.1 bar.

The suspension transported in the tanker lorry was diluted with water to a pulp concentration of app. 1% and was fed to the pressurized screen 13. A mass balance study of the experiment in percent gave the following results.

100 parts were fed into the screen 13 and 80 parts were taken out through line 14 (this fraction can be termed fibre fraction) and 20 parts were taken out through line 15 (this fraction can be termed fine material fraction). The fibre fraction in line 14 was diluted with water before it was fed into the second screening stage 16. 70 parts were taken out from the screen 16 through line 18 and 10 parts were taken out through line 19 and this material stream was fed into line 15. Thus 30 parts were fed to the first fractionating cyclone 20. The apex fraction in the cyclone made up to 16 parts and this material stream was, after dilution with water, conducted to the other fractionating cyclone 23. The base fraction from that cyclone was through line 25 conducted to line 21 and the final material stream in this line make up to 20 parts and the material consists of flakes of middle lamellas (from pulp fibers) and fibrils. The apex fraction from cyclone 23 was conducted to a screen 27. This screen was not a pilot plant scale screen but a laboratory screen type Dynamic Drainage Jar (a 10 liter container with a wire in the bottom and an agitator to prevent clogging of the wire). This device didn't have a screen plate with long and narrow slots or round holes, but a wire with a mesh width of 50 mesh. In this screen 5 parts (fibers) were recovered which were introduced into line 18 through line 29 and 5 parts ray cells, which were taken away through line 28.

To sum up, the described fractionating of the pulp according to one embodiment of the invention, led to the result that of incoming 100 parts of pulp 95 parts useful and valuable material suitable for e.g. paper production (75 parts prime fibers and 20 parts usable and valuable fibrils and flakes of middle lamellas) were recovered and 5 parts invaluable material were recovered in the form of ray cells.

Freeness value (m1), concentration (%) and flow (1/s) of the advancing material stream were measured in certain positions. In certain positions the material was not of such a kind that for example the freeness value could be measured. A number of such data are presented below.

The data in question for the incoming pulp suspension in pipe 12 were 501, 1.1 and 11.7. The data for the fibre fraction in pipe 14 when it enters the screen 16 were 692, 1.3 and 8.4 and for the fibre fraction in the outlet from the screen 16 in pipe 18 the data were 720, 2.8 and 2.6 respectively. The data for the fine material fraction from the screen 13 in pipe 15 were 20, 0.3 and 8.3 respectively. For the material fraction from the screen 16 in pipe 19 the data were 52, 0.21 and 5.8. For the unified fraction in pipes 15 into the cyclone 20 the data were 28, 0.26 and 14.1 respectively.

Further the pulp suspension in different positions at the two screening stages were microscopically examined to find out the number distribution between fibers and ray cells. The percentage number distribution (N.B. not weight percent) appears from the following table.

TABLE 1

| | | Pulp suspension | |
|---|---|---|---|
| | Pulp suspension | in the outlet from | Pulp suspension |
| | in pipe 12 | screen 13 in pipe 15 | in pipe 18 |
| Fibers, % | 61 | 43 | 97 |
| Ray cells, % | 39 | 57 | 3 |

It can be noted that the number of ray cells in the accept fibre fraction in pipe 18 is almost negligible and substantially all of the originally present ray cells can be found in the material fraction which is fed into the fractionating cyclone 20. By means of the two fractionating cyclones 20 and 23 it is possible to separate, almost completely, one type of fine material, i.e. fibrils and flakes of middle lamellas, from other not wanted type of fine material, i.e. ray cells.

One further investigation was carried out, wherein thin pulp sheets or, if you like, paper sheets, were produced of the pulp suspension from pipe 18 plus the fine material fraction from pipe 21. Before mixing these two types of material, the pulp suspension from pipe 18 was beaten at a pulp concentration of 35.7% in a refiner type RGP44 at 1.500 rpm and a pressure of 300 kPa and a production of 410 kg/h. For comparison thin pulp sheets or, if you like, paper sheets, were produced of a reference pulp made up of all three fractions (beaten fibres, valuable fine material and ray cells) in proportions corresponding to the original pulp.

These pulp sheets were subjected to a number of measurements, namely tensile index (Nm/g) and elongation (%) according to SCAN-M 8:76 (with reference to SCAN-P 16:76) and light-scattering (%) according to SCAN-M 7:76. It turned out that the tensile strength of the pulp substantially free from ray cells, i.e. the one treated according to the invention, was 18% higher than the tensile strength of the reference pulp, while the elongation was 20% higher. The light scattering of the pulp according to the invention was only 5% lower than the light scattering of the reference pulp.

1. A method for selective removal of ray cells from cellulose pulp, wherein at first an advancing pulp suspension is screened or vortex cleaned, whereby an accept pulp suspension and a reject pulp suspension are provided, the reject pulp fraction is cleaned and divided and accept material (pulp fibres and valuable fine material) is brought to further treatment and/or use, characterized in that the cleaning and division of the reject pulp suspension is carried out so that substantially all ray cells are recovered in the apex fraction of a fractionating cyclone (if that kind of device is used) and in that said fraction as such constitutes a very limited material stream containing predominantly ray cells, or in that a very limited material stream containing predominantly ray cells is selected from the apex fraction, and in that this very limited material stream is brought to a disposal stage.

2. A method according to claim 1, characterized in that the measures to remove ray cells from the cellulose pulp are taken in any position anywhere from immediately after the fibre liberation stage to the short white water circulation system at the paper/paperboard manufacturing.

3. A method according to claim 1-2, characterized in that the cellulose pulp consists of mechanical pulp.

4. A method according to claim 3, characterized in that the measures are taken directly after the fibre liberation, i.e. after the defibration in one or two steps of the lignocellulose material.

5. A method according to any of claims 1-4, characterized in that the introductory screening of the pulp suspension is carried out in a pressurized screen with a screen plate having long and narrow slots with a width up to at most 0.1 mm, or circular holes with a diameter up to at most 0.5 mm.

6. A method according to any of claims 1-5, characterized in that the steps of cleaning and dividing the reject pulp suspension, i.e. said fine material, are directed to the differences in specific surface area between ray cells and other valuable fine material by using the differences in hydrodynamic resistance of these two types of material.

7. A method according to claim 6, characterized in that when the cleaning device consists of a fractionating cyclone, a certain balance is set between the hydrodynamic flow force and the gravitational-/centrifugal force thereof.

8. A method according to any of claims 1-7, characterized in that the amount of fine material, in the form of predominately ray cells, removed from the cellulose pulp, is at most 5% of the original weight of the cellulose pulp.
